(19) United States
(12) Patent Application Publication
(10) Pub. No.: US 2025/0084548 A1
(43) Pub. Date: Mar. 13, 2025

(54) IMPROVED DURABILITY OF DIAPHRAGM FOR HIGHER TEMPERATURE ELECTROLYSIS

(71) Applicant: Green Hydrogen Systems A/S, Kolding (DK)

(72) Inventors: Martin Kalmar HANSEN, Kolding (DK); Kasper Tipsmark THERKILDSEN, Kolding (DK)

(73) Assignee: Green Hydrogen Systems A/S, Kolding (DK)

(21) Appl. No.: 18/290,616

(22) PCT Filed: Jul. 19, 2022
(86) PCT No.: PCT/EP2022/070136

§ 371 Date: Jan. 19, 2024

(30) Foreign Application Priority Data
Jul. 20, 2021 (EP) 21186621.5

(51) Int. Cl. C25B 13/08; C08J 3/24; C25B 1/04; H01M 8/1032; H01M 8/1088; H01M 50/403; H01M 50/414

(52) U.S. Cl. CPC C25B 13/08; C08J 3/24; C25B 1/04; C08J 2381/06; H01M 8/1032; H01M 8/1088; H01M 50/403; H01M 50/414

(57) ABSTRACT

Present invention relates to a novel method of preparing a diaphragm.

### FIELD OF THE INVENTION

Present invention relates to the field of electrochemical cells and in particular to separator membranes or diaphragms for use in electrochemical applications. Present invention also relates to a process for preparing membranes or diaphragms for use in any electrochemical application or process.

### BACKGROUND OF THE INVENTION

In the art, several solutions for providing separator elements for use in electrochemical applications have been presented. As the reaction conditions and the chemicals used during such electrolysis applications may be harsh, various solutions for providing separator elements that can withstand and function during the electrolysis reaction have been presented. In e.g. WO 2009/147084, a membrane is provided which relates to an ion-permeable web reinforced separator. Specifically, the document relates to self-supporting ion-permeable web-reinforced separators with an entirely symmetrical structure and substantially flat surfaces.

However, there remains a need for the provision of membranes or diaphragms that exhibit higher thermal and chemical stability during electrolysis conditions.

### SUMMARY OF THE INVENTION

Present invention relates to the provision of a diaphragm that may be used in any electrochemical application, such as e.g. electrolysis and specifically in e.g. alkaline water electrolysis, batteries (alkaline and acid), fuels cells and the likes.

Present invention relates to solving the problem with providing a diaphragm that exhibits higher thermal stability and/or chemical stability etc.

Present invention also relates to a process or method of preparing a diaphragm according to the invention.

Thus, in one aspect, present invention relates to a method or process of preparing a diaphragm, comprising the steps of;
i) providing a diaphragm piece comprising e.g. a sulfone based polymer, ii) functionalizing the sulfone based polymer, by e.g. sulfonation in concentrated sulphuric acid at elevated temperature for an extended period of time,
iii) rinsing the resulting functionalized diaphragm from ii) in cold demineralised water,
iv) further processing the diaphragm piece comprising one of;
   a) optionally drying the rinsed functionalized diaphragm from step iii), at elevated temperature for an extended period of time or until the diaphragm is essentially free of water, or
   b) displacing water with a cross-linking agent in the diaphragm matrix, or
   c) adding a cross-linking agent in the diaphragm matrix after drying the functionalised diaphragm in a),
v) crosslinking the dried diaphragm in iv), at elevated temperature for an extended period of time,
vi) after completion of the crosslinking step v) the diaphragm is rinsed in demineralized water and treated with an alkaline water solution for an extended period of time,
vii) rinsing the alkaline treated diaphragm in step vi) with demineralized water and subsequently boiled in demineralized water for an extended period of time.

In one aspect, present invention relates to a diaphragm obtainable by the process or method according to the invention.

In a further aspect, present invention relates to use of a diaphragm according to the invention in any electrochemical application. Particularly, present invention relates to use of a diaphragm in any electrochemical application wherein the reaction temperature is above 80° C.

In one non-limiting aspect, present invention relates to a diaphragm, which may comprise one or more polymers, polymers types or co-polymers. In one aspect, the polymer may be sulfone based. In yet a further aspect, the sulfone based polymer may be cross-linked.

### Definitions

According to the invention, a “diaphragm”, or “membrane” which may be used interchangeably throughout the description, is intended to mean any type of element which separates the anode from the cathode in an electrolytic cell, and may be placed anywhere in between the anode and the cathode being in connection via an electrolyte. The diaphragm is ion-permeable but substantially impermeable to gases of any type, in particular impermeable to oxygen and hydrogen gas.

The term “electrochemical application” is intended to mean any application which comprises the employment of at least one anode, at least one cathode and an electrolyte. Such applications may comprise e.g. water splitting, any battery application (alkaline or acid based), any type of fuel cells etc.

The term “casted” or “pressed” which may be used interchangeably throughout the description is intended to mean any of the well-known processes of casting flat polymer membranes from a fluid or semifluid composition of a polymer dissolved in a solvent, such as on a roll, in a flat mold, or by extrusion into a fluid bath. An example of this can be found in document WO2009147086A1, which is incorporated herein by reference in its entirety. Further examples can be found in https://synderfiltration.com/learning-center/articles/introduction-to-membranes/phase-inversion-membranes-immersion-precipitation/, which is also incorporated herein by reference in its entirety.

### DETAILED DESCRIPTION OF THE INVENTION

Present invention relates to the provision of a diaphragm that may be used in any electrochemical application. According to the invention, the diaphragm comprises a polymer, which may be cross-linked. One important aspect of the invention is that the crosslinking takes place after the diaphragm has been casted. Another important aspect of the invention is that the diaphragm is thermally and/or chemical stable. In e.g. alkaline electrolysis the most common gas separator is a diaphragm. As is known in the art, a diaphragm is a porous structure with gas separation and ionic conductivity capabilities provided by the uptake of the liquid electrolyte. In most industrial applications in alkaline electrolysis, the electrolyte is a concentrated (30 wt %) potassium hydroxide (KOH) solution. The common operational temperature is up to about 80-100° C., where most systems are recommended to operate around 80° C. The strong alkaline solution and the presence of oxygen presents a very harsh environment for most materials commonly used in electrolytic methods. The state-of-the-art diaphragm on the commercial market is Zirfon UTP500, which is a composite material consisting of inorganic particles (zirconium oxide), polymeric binder material and a polymeric mesh. However, the polymeric binder, which in the state-of-the-art example is a polysulfone type of polymer, which stability in the alkaline electrolysis environment dramatically decreases at temperatures above 100-110° C. Presently in the art, it is the stability of the diaphragm, which is determining the operating temperature of the electrolyser unit. Substantial gains in electrolyser efficiency can be achieved by elevating the temperature to e.g. about 120° C. Initial experiments have shown that increasing the temperature with 10° C. lowers the cell voltage and increases the stack efficiency with 2-3% per 10° C. Consequently, there is an unmet need for chemically and/or thermally stable diaphragms. In the art, the common procedure to prepare composite diaphragms is limited by the narrow relationships between the amount of polymeric binder, solvent to dissolve the polymeric binder and the inorganic particles in order to achieve a diaphragm with the best properties as a gas separator material. It is known in the art that polymeric materials which has a higher molecular weight (chain length) shows improved stability (i.e. last longer before the integrity of the diaphragm is lost) in harsh environments such as for alkaline electrolysis. Another way to obtain more stable polymers is to crosslink the polymeric material. However, both paths to increased stability also limit the solubility of the polymer in the solvent and hence it is not possible to achieve desired properties of the diaphragm owing to the ratio between the three components (binder, solvent and inorganic particles) being less than optimum in the finished diaphragm.

The inventors of present invention have surprisingly found that it is possible to improve the thermal and/or chemical stability of the diaphragm by first casting the diaphragm and thereafter perform reactions that will result in the crosslinking of the binding polymer.

Consequently, present invention relates to a process or method for obtaining a diaphragm, the process comprising the steps of;
i) providing a diaphragm piece comprising e.g. a polymeric binder,
ii) functionalizing the polymer binder, wherein the resulting functionalisation enables crosslinking,
iii) optionally rinsing the resulting functionalized diaphragm from step ii) in water,
iv) further processing the diaphragm piece comprising one of;
   a) optionally drying the rinsed functionalized diaphragm from step iii), at elevated temperature for an extended period of time or until the diaphragm is essentially free of water, or
   b) displacing water with a cross-linking agent in the diaphragm matrix, or
   c) adding a cross-linking agent in the diaphragm matrix after drying the functionalised diaphragm in a),
v) crosslinking the dried diaphragm resulting from step iv), at elevated temperature for an extended period of time,
vi) after completion of the crosslinking from step v) the diaphragm is rinsed in demineralized water and treated with an alkaline water solution for an extended period of time,
vii) rinsing the alkaline treated diaphragm in step vi) with demineralized water and subsequently boiled in demineralized water for an extended period of time.

As is apparent from present description, the invention relates to a method wherein the diaphragm is provided in a casted or pressed form.

Consequently, in one aspect, the diaphragm in step i) is provided in a casted form. As is also apparent for a person skilled in the art, the provided casted or pressed diaphragm comprises a suitable scaffolding such as e.g. a polymeric mesh, gauze or cloth. A non-limiting example may be a mesh of e.g. polytetrafluoroethylene. Other examples are various non-woven fibres of any suitable kind. Other non-limiting examples are e.g. polyether ether ketone (PEEK), Polyphenylene sulfide (PPS), Ethylene-Tetrafluoroethylene (ETFE) or co-polymers thereof.

As is also evident to a person skilled in the art, the diaphragm according to the invention comprises a suitable metal oxide or other suitable material enabling ionic conductivity through the diaphragm. Such metal oxides may be oxides of titanium, nickel, vanadinum, etc. Other examples may be polytitanic acid, polyzirconic acid or, or zirconium oxide, titanium dioxide, aluminum oxide, talc, barium sulfate or potassium titanate, and hydrous inorganic gels such as magnesium oxide gel, zirconium oxide gel, titanium oxide gel or zirconyl phosphate gel.

Various polymers may be used in accordance to the invention. One non-limiting example is a sulfone based polymer. One specific non-limiting example may be e.g. polyphenylsulfone (PPSU). Other specific non-limiting examples are polymers of polyvinylidene chloride, polyacrylonitrile, polyethyleneoxide, polymethylmethacrylate or copolymers of such polymers. The polymeric binder must be susceptible to further functionalization or configures such that cross linking is possible. Non-limiting examples are e.g. halomethylation, lithiation, bromination, aminomethylation etc. A further non-limiting example is that the polymeric binder is sulfonated by reacting the polymer with concentrated sulfuric acid. An exemplary non-limiting examples is seen in the scheme below:

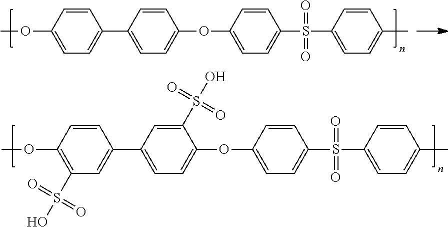

The reaction conditions for functionalising the polymeric binder may vary with reagent and the polymer type and is easily conceived by the knowledge of a person skilled in the art. In the example above, PPSU is subjected to a sulfonation reaction in the presence of sulphuric acid. Preferably, the sulphuric acid is concentrated and i.e. in concentration of 98 wt %.

The temperature of the reaction during the functionalisation of the polymer may be in range of e.g. about 40° C. to about 80° C., such as e.g. about 45° C., such as e.g. about 50° C., such as e.g. about 55° C., such as e.g. about 60° C., such as e.g. about 65° C., such as e.g. about 70° C., such as e.g. about 75° C., etc.

In one particular aspect, the temperature during the functionalisation of the polymer may be in range of about 75° C. to about 85° C. In yet a further aspect, the temperature during the functionalisation of the polymer may be about 80° C.

The reaction time for the functionalisation of the polymer may be in range of e.g. about 1 h to about 48 h, such as e.g. about 3 h, such as e.g. about 4 h, such as e.g. about 5 h, such as e.g. about 6 h, such as e.g. about 7 h, such as e.g. about 8 h, such as e.g. about 9 h, such as e.g. about 10 h, such as e.g. about 11 h, such as e.g. about 12 h, such as e.g. about 24 h, or such as e.g. about 48 h etc.

In one aspect, the reaction time for the functionalisation of the polymer may be in range of about 14 h to about 18 h. In yet a further aspect, the reaction time for the functionalisation of the polymer may be about 16 h.

After completion of the functionalisation reaction of the polymer, the reagents used in the reaction are removed from the functionalized polymer by any suitable purification method. Such method may comprise e.g. rinsing in demineralised water. The water may have a temperature of e.g. about 0° C. to about 5° C. This step is performed to stop the reaction. However, depending on the reagents used in the reaction any solvent or solvent mix may be used to rinse away remaining reagent. Non-limiting examples may be e.g. alcohols or DMF (dimethyl formamide), or DMSO (dimethyl sulfoxide), or any mixtures thereof. In the example above, rinsing may be considered complete when the rinsing fluid has essentially a neutral pH, i.e. in range of from about 5.5. to about 6.5.

Optionally, the rinsed functionalised polymer may be dried from the solvents used in the rinsing process. Drying may take place at any suitable temperature such as e.g. from about 20° C. to about 80° C. and may proceed during a period from about 12 h to about 48 h such as e.g. about 24 h.

In one particular aspect, the drying temperature may be in range of about 75° C. to about 85° C. In yet a further aspect, the drying temperature may be about 80° C.

In a further aspect, the drying may proceed during a period in range of about 14 h to about 18 h. In yet a further aspect, drying may proceed during a period of about 16 h.

As is mentioned herein, the diaphragm may optionally be dried after step ii), i.e. after functionalizing the polymer binder. As an alternative, and instead of drying the diaphragm after the polymer therein has been functionalised, any water or other solvent present in the polymer matrix may be exchanged or otherwise replaced/displaced by a crosslinking agent to avoid pore collapsing which may occur in some instances when drying the diaphragm, i.e. removing water from the diaphragm. Pore collapsing in the polymeric matrix or structure may contribute to reduced ionic conductivity of the diaphragm. The crosslinking agent may be e.g. a di-alcohol, such as e.g. ethylene glycol or propylene glycol, or a tri-alcohol such as e.g. glycerol.

As a further alternative, the diaphragm may be dried after step ii), i.e. after functionalizing the polymer binder. After the diaphragm is considered sufficiently dried (free of or reduced amount of water), a crosslinking agent may be added. Such cross-linking agent may be e.g. a di-alcohol, such as e.g. ethylene glycol or propylene glycol, or a tri-alcohol such as e.g. glycerol. Thus, in this aspect, the cross-linking agent will be allowed to soak or otherwise diffuse into the diaphragm structure or matrix.

As yet a further alternative, the diaphragm may be dried after step ii), i.e. after functionalizing the polymer binder without addition of any crosslinking agent.

Once the polymer has been sufficiently functionalised, the polymer is cross-linked. The crosslinking reaction may be by means of thermal crosslinking or may be initiated by radical crosslinking or may even be effectuated by UV-irradiation of the polymer. The type of crosslinking reaction, i.e. the manner of initiating the reaction of accomplishing the reaction will be apparent to a person skilled in the art and will of course depend on the functionality of the polymer. In the example above, thermal treatment may be employed to bring about the crosslinking. The temperature employed to bring about the crosslinking may be in the range of about 180° C. to about 240° C., such as e.g. about 190° C., such as e.g. about 200° C., such as e.g. about 210° C., such as e.g. about 220° C., such as e.g. about 230° C., etc. In one particular aspect, the cross-linking temperature may be about 220° C. The reaction time for the crosslinking may be in range of from about 12 h to about 48 h, such as e.g. about 24 h. In a particular aspect, the reaction time for the crosslinking may be about 12 h. An example of the reaction is illustrated in the scheme below. This would illustrate the method according to the invention without the use of a cross-linking agent.

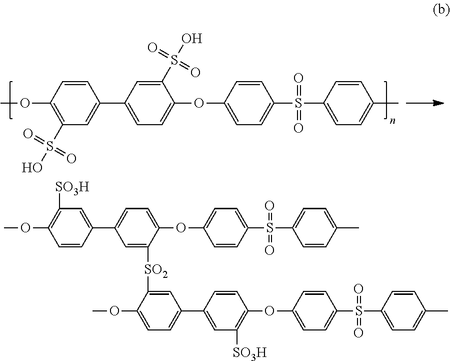

Optionally, and as mentioned above, a crosslinking agent may be employed, such as e.g. a di-alcohol, such as e.g. ethylene glycol or propylene glycol, or a tri-alcohol such as e.g. glycerol. In fact any moiety having a bi- or trifunctional reactive group may be employed for the purpose as long as the boiling point of the agent is sufficiently high and in parity with the reaction temperature of the crosslinking reaction. A non-limiting example is illustrated in the scheme below.

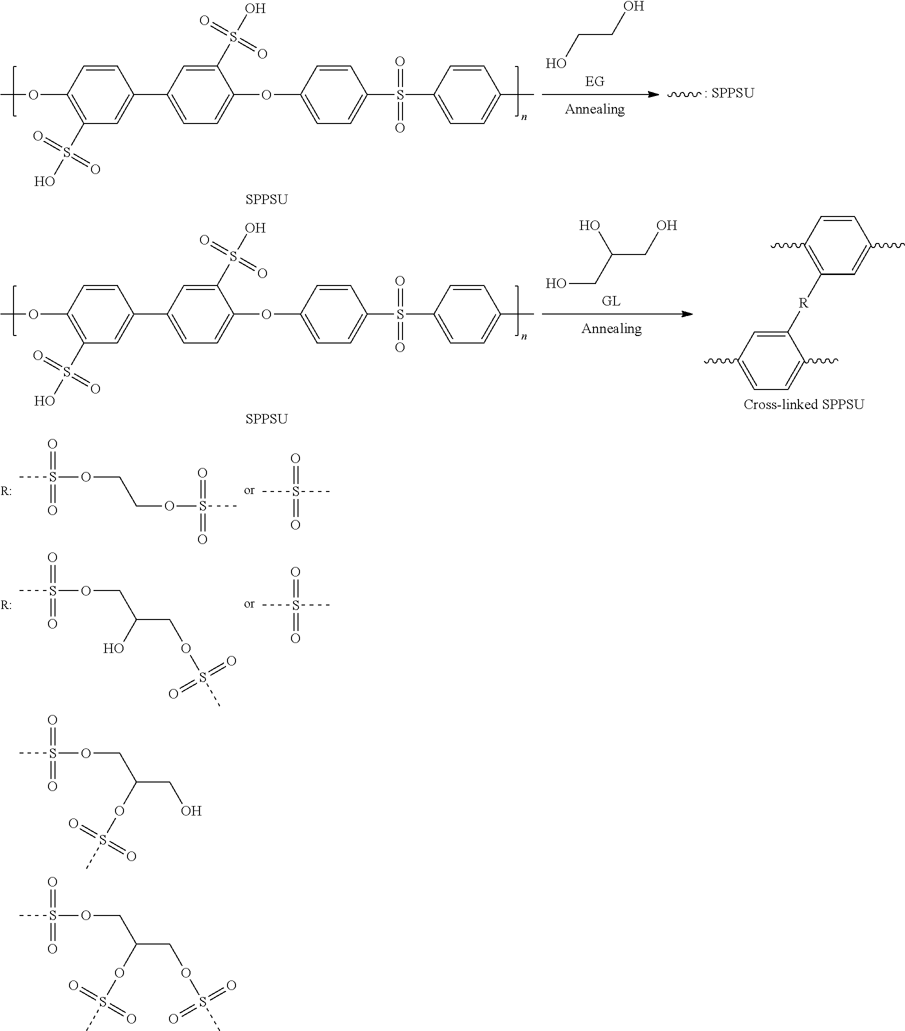

As is apparent from the above, the process according to the invention may include a cross-linking agent or may not employ or include a cross-linking agent. After completion of the crosslinking reaction, the diaphragm is washed with a suitable solvent or solvent mixture. For example, the diaphragm may be rinsed in demineralised water. The water may have ambient temperature. However, depending on the reagents used in the reaction any solvent or solvent mix may be used to rinse away remaining reagent. Non-limiting examples may be e.g. alcohols or DMF (dimethyl formamide), or DMSO (dimethyl sulfoxide), or any mixtures thereof. After rinsing, the diaphragm may be further treated to remove any traces of by-products from the crosslinking reaction. In the example above, the diaphragm may be immersed in an alkaline aqueous solution. The solution may be a KOH solution of a strength of about 5 wt % to about 30 wt %, and the treatment of the diaphragm may proceed for a period of about 2 h to about 48 h, such as e.g. about 12 h, or about 48 h.

In the final step of the preparation, the diaphragm may be rinsed in demineralised water and subsequently boiled in demineralised water during a period of about 30 min to about 2 h, such as e.g. for about 60 min, or e.g. about 90 min.

Consequently, present invention relates to a diaphragm obtainable by a process according to the invention.

In another aspect, present invention relates to a use diaphragm according to the invention in any electrochemical application.

In a further aspect, present invention relates to use of diaphragm according to the invention as an element in any electrochemical device.

Specifically, the use of the diaphragm according to the invention may be as an element in any electrochemical device or any application adapted or configured for electrolysis of water such as e.g. water splitting into oxygen and hydrogen.

The device or application may comprise electrolysis in an alkaline environment and concretely employing an alkaline aqueous solution as an electrolyte. A non-limiting example may be an aqueous KOH-solution of a concentration of about 30 wt % or more acting as an electrolyte.

In one aspect, the use according to the invention may comprise an alkaline electrolyte, wherein the electrolyte may be heated to an elevated temperature. In a further aspect, the elevated temperature may be in range of from about 50° C. to about 150° C., or alternatively e.g. above about 120° C., or e.g. above about 100° C., or e.g. above about 80° C.

In a particular aspect, the elevated temperature is above about 80° C.

In a further aspect, the use of the diaphragm according to the invention is such that the diaphragm may be configured such that it is able to accommodate or absorb the electrolyte owing to its porosity and consequently, the electrolyte is capable to enter the porous structure of the diaphragm. This in turn enables ionic conductivity through the membrane while the membrane still separates the oxygen gas from the hydrogen gas produced at the anode and cathode respectively on each side of the diaphragm.

In yet a further aspect, present invention relates to a diaphragm comprising a cross-linked polymer binder.

In one aspect, the invention relates to a diaphragm comprising a cross-linked polymer binder, wherein the polymer binder is polyphenylsulfone (PPSU).

The polymer binder may in one aspect, be functionalised by incorporation of a sulfonic acid group. This may be accomplished by the aid of concentrated sulphuric acid.

In a further aspect, the diaphragm may comprise a scaffolding. The scaffolding may be e.g. a polymeric mesh, gauze, net or cloth etc.

In yet a further aspect the diaphragm may comprise a metal oxide or a metal. In one aspect the metal oxide component may be any suitable metal oxide or other suitable material enabling ionic conductivity through the diaphragm. Such metal oxides may be oxides of titanium, nickel, vanadinum, etc. Other examples may be polytitanic acid, polyzirconic acid or, or zirconium oxide, titanium dioxide, aluminum oxide, talc, barium sulfate or potassium titanate, and hydrous inorganic gels such as magnesium oxide gel, zirconium oxide gel, titanium oxide gel or zirconyl phosphate gel.

As an example, the metal oxide, such as e.g. ZrO₂, may be added to the polymeric binder to make the diaphragm more hydrophilic (increase wettability) and as a further consequence thereof increase ionic conductivity of the finished diaphragm.

An exemplary non-limiting method of preparing a diaphragm comprising a metal oxide may be by adding the metal oxide to the polymer binder/polymer forming a slurry type of mixture and thus;
Step 1: dissolving the polymer/polymer binder in a suitable solvent, such as e.g. N-Methyl-2-pyrrolidone (NMP),
Step 2: Mixing the polymer/solvent mixture with a metal oxide particles. The mixing may be conducted during several hours and under vacuum to ensure a homogenous mixture and avoiding or eliminating inclusion of air bubbles, Step 3: casting the diaphragm according to the invention after the solvent has been substantially removed. Thus, the diaphragm will solidify upon removal of the solvent such that the polymeric binder/polymer with metal oxide will solidify and enclosing the scaffolding (if used) which may be a net or a grid etc.

Thus, the casted diaphragm will act like a porous structure enclosing the metal oxide particles and forming a porous medium capable of accommodating the electrolyte fluid.

In specific embodiments, present invention also relates to the following items:

### Items

1. A process or method for obtaining a diaphragm, the process comprising the steps of;
i) providing a diaphragm piece comprising a polymeric binder,
ii) functionalizing the polymeric binder, wherein the resulting functionalisation enables crosslinking,
iii) optionally rinsing the resulting functionalized diaphragm from step ii) with a solvent,
iv) further processing the diaphragm piece comprising one of;
   a) optionally drying the rinsed functionalized diaphragm from step iii), at elevated temperature for an extended period of time or until the diaphragm is essentially free of water, or
   b) displacing water with a cross-linking agent in the diaphragm matrix, or
   c) adding a cross-linking agent in the diaphragm matrix after drying the functionalised diaphragm in a),
v) crosslinking the dried diaphragm resulting from step iv), at elevated temperature for an extended period of time,
vi) after completion of the crosslinking from step v) the diaphragm is rinsed in solvent and optionally post treated.

2. The process or method for obtaining a diaphragm according to item 1, wherein the polymeric binder is a sulfone based polymer such as e.g. polyphenylsulfone (PPSU), or polyvinylidene chloride, polyacrylonitrile, polyethyleneoxide, polymethylmethacrylate or copolymers of such polymers.

3. The process or method for obtaining a diaphragm according to any of the preceding items, wherein the functionalisation reaction in step ii) result in a sulfonation reaction providing the addition of a —SO₃H group to the polymeric binder, or wherein the functionalisation reaction in step ii) result in a halomethylation, lithiation, bromination, aminomethylation etc.

4. The process or method for obtaining a diaphragm according to any of the preceding items, wherein the crosslinking agent is a di-alcohol, such as e.g. ethylene glycol or propylene glycol, or a tri-alcohol such as e.g. glycerol.

5. The process or method for obtaining a diaphragm according to any of the preceding items, wherein the functionalisation reaction in step ii) is performed at a temperature in range of e.g. about 40° C. to about 80° C., such as e.g. about 45° C., such as e.g. about 50° C., such as e.g. about 55° C., such as e.g. about 60° C., such as e.g. about 65° C., such as e.g. about 70° C., such as e.g. about 75° C., etc. and for a period in range of about 1 h to about 48 h, such as e.g. about 1 h to about 48 h, such as e.g. about 3 h, such as e.g. about 4 h, such as e.g. about 5 h, such as e.g. about 6 h, such as e.g. about 7 h, such as e.g. about 8 h, such as e.g. about 9 h, such as e.g. about 10 h, such as e.g. about 11 h, such as e.g. about 12 h, such as e.g. about 24 h, or such as e.g. about 48 h etc.

6. The process or method for obtaining a diaphragm according to any of the preceding items, wherein the rinsing in step iii) is performed by rinsing the diaphragm in a suitable solvent such as e.g. demineralised water, or an alcohol, or DMF, or e.g. DMSO or any mixtures thereof and wherein the solvent may have a temperature of about 0° C. to about 5° C.

7. The process or method for obtaining a diaphragm according to any of the preceding items, wherein the drying step in step iv) is performed at a temperature in range of from about 20° C. to about 80° C. and during a period from about 12 h to about 48 h such as e.g. about 24 h.

8. The process or method for obtaining a diaphragm according to any of the preceding items, wherein the crosslinking reaction in step v) is performed by means of thermal crosslinking or initiated by radical crosslinking or be effectuated by UV-irradiation of the polymer, and optionally performed in the presence of a further crosslinking reagent such as e.g. ethylene glycol, propylene glycol or glycerol.

9. The process or method for obtaining a diaphragm according to any of the preceding items, wherein the crosslinking reaction in step v) is performed at an elevated temperature in the range of about 180° C. to about 240° C., such as e.g. about 190° C., such as e.g. about 200° C., such as e.g. about 210° C., such as e.g. about 220° C., such as e.g. about 230° C., etc. and for a reaction time in range of from about 12 h to about 48 h, such as e.g. about 24 h.

10. The process or method for obtaining a diaphragm according to any of the preceding items, wherein the rinsing in step vi) is performed demineralised water, or an alcohol, or DMF, or e.g. DMSO or any mixtures thereof.

11. The process or method for obtaining a diaphragm according to any of the preceding items, wherein the post treatment in step vi) may comprise treating the diaphragm in an alkaline water solution, such as e.g. a KOH solution of a strength of about 5 wt % to about 30 wt %, and the treatment of the diaphragm may proceed in the alkaline solution for a period of about 2 h to about 48 h, such as e.g. about 12 h, or about 48 h.

12. The process or method for obtaining a diaphragm according to any of the preceding items, wherein the process may comprise an additional step vii) which follows step vi), wherein the diaphragm is rinsed in demineralised water and subsequently boiled in demineralised water during a period of about 30 min to about 2 h, such as e.g. for about 60 min, or e.g. about 90 min.

13. A diaphragm obtainable by a process according any of items 1-12.

14. Use of a diaphragm according to item 13 in any electrochemical application.

15. A diaphragm comprising a cross-linked polymer binder, wherein the polymer binder is sulfone based polymer such as e.g. polyphenylsulfone (PPSU), and which is optionally crosslinked by ethylene glycol or glycerol.

### EXAMPLES

In the following, the invention is illustrated by a non-limiting example. The example illustrates method of preparing a diaphragm according to the invention.
Step 1: dissolving the polymer/polymer binder (such as e.g. PPSU) in a suitable solvent, such as e.g. N-Methyl-2-pyrrolidone (NMP),
Step 2: Mixing the polymer/solvent mixture with a metal oxide particles (e.g. ZrO₂). The mixing may be conducted during several hours and under vacuum to ensure a homogenous mixture avoiding inclusion of air bubbles, Step 3: casting the diaphragm according to the invention and removing the solvent. Thus, the diaphragm will solidify in the cast shape upon removal of the solvent such that the polymeric binder/polymer with metal oxide will solidify and enclosing the scaffolding which may be a net or a grid etc.

A casted diaphragm (according to the above) comprising polyphenylsulfone (PPSU) was subjected to a sulfonation reaction by treatment of concentrated H₂SO₄ (98 wt %) at elevated temperatures (80° C.) for 16 hours. After the reaction, the diaphragm was rinsed thoroughly in cold (5° C.) demineralized water to stop the sulfonation reaction of the polymer back bone. The sulfonated diaphragm was dried at 80° C. for 16 hours before the thermal curing process was commenced.

Crosslinking was performed by heating the diaphragm to a temperature of 220° C. for 12 hours. In a separate experiment, a crosslinking agent was added in from of ethylene glycol in one instance and in a separate experiment glycerol was added which resulted in a tethering or bridging the —SO₃H groups on the polymeric backbone.

After the crosslinking, the diaphragm is washed thoroughly with demineralized water before being immersed in 15 wt % KOH for 24 hours. Activation of the diaphragm in KOH is an important step which removes any residues of SO₂ (SO₂ reacts with KOH to form K₂SO₄ and H₂O), since SO₂ can promote instability of the diaphragm. Finally, the diaphragm was washed with demineralized water and boiled for 2 hours in demineralized water.

The obtained diaphragm was tested both in an full electrolytic cell employing an alkaline electrolyte (about 30 wt % KOH aqueous solution) as well as ex-situ test setups as immersing in a pressurized durability test tank(s) (30 wt % KOH, pure oxygen bubbling through and temperatures of 110, 120, 130, 140 and 150° C., where the life time is compared with traditional non-crosslinked diaphragms. Furthermore, properties like ionic conductivity, liquid permeability and gas separation capabilities are also tested in ex-situ setups. The ultimate test combining all the characteristic from above is in-situ cell testing for several thousand hours at 120, 130, 140 and 150° C. It was found that the diaphragm obtained by the methods of the invention and incorporated into an electrolytic cell displayed same or improved excellent conductivity as the non-crosslinked counterparts throughout the temperatures indicated above, but more importantly and remarkably so, showed significant longer life-time (not losing mechanical integrity) at the higher end of the experimental temperatures. After completion of the experiments, the diaphragm was visually inspected and found to be intact (mechanical sound), with virtually none signs of degradation and still showing almost the same gas separation capabilities as before the test.

1. A process or method for obtaining a diaphragm, the process comprising the steps of;
i) providing a casted diaphragm piece comprising a polymeric binder,
ii) functionalizing the polymeric binder, wherein the resulting functionalisation enables crosslinking,
iii) optionally rinsing the resulting functionalized diaphragm from step ii) with a solvent,
iv) further processing the diaphragm piece comprising
a) drying the rinsed functionalized diaphragm from step iii), at about 20° C. to about 80° C. and during a period from about 12 h to about 48 h, or until the diaphragm is essentially free of solvent and adding a cross-linking agent in the diaphragm matrix after drying the functionalised diaphragm, or
b) displacing the solvent with a cross-linking agent in the diaphragm matrix, wherein the cross-linking agent is a di-alcohol, such as e.g. ethylene glycol or propylene glycol, or a tri-alcohol such as e.g. glycerol,
v) crosslinking the dried diaphragm resulting from step iv), at about 180° C. to about 240° C. during a period of about 12 h to about 48 h,
vi) after completion of the crosslinking from step v) the diaphragm is rinsed in solvent and optionally post treated.

2. The process or method for obtaining a diaphragm according to claim 1, wherein the polymeric binder is a sulfone based polymer such as e.g. polyphenylsulfone (PPSU), or polyvinylidene chloride, polyacrylonitrile, polyethyleneoxide, polymethylmethacrylate or copolymers of such polymers.

3. The process or method for obtaining a diaphragm according to claim 1, wherein the functionalisation reaction in step ii) result in a sulfonation reaction providing the addition of a —SO₃H group to the polymeric binder, or wherein the functionalisation reaction in step ii) result in a halomethylation, lithiation, bromination, aminomethylation etc.

4. The process or method for obtaining a diaphragm according to claim 1, wherein the functionalisation reaction in step ii) is performed at a temperature in range of e.g. about 40° C. to about 80° C., such as e.g. about 45° C., such as e.g. about 50° C., such as e.g. about 55° C., such as e.g. about 60° C. such as e.g. about 65° C. such as e.g. about 70° C., such as e.g. about 75° C., etc. and for a period in range of about 1 h to about 48 h, such as e.g. about 1 h to about 48 h, such as e.g. about 3 h, such as e.g. about 4 h, such as e.g. about 5 h, such as e.g. about 6 h, such as e.g. about 7 h, such as e.g. about 8 h, such as e.g. about 9 h, such as e.g. about 10 h, such as e.g. about 11 h, such as e.g. about 12 h, such as e.g. about 24 h, or such as e.g. about 48 h etc.

5. The process or method for obtaining a diaphragm according to claim 1, wherein the rinsing in step iii) is performed by rinsing the diaphragm in a suitable solvent such as e.g. demineralised water, or an alcohol, or DMF, or e.g. DMSO or any mixtures thereof and wherein the solvent may have a temperature of about 0° C. to about 5° C., and wherein the drying step in step iv) is performed during a period of about 24 h.

6. The process or method for obtaining a diaphragm according to claim 1, wherein the crosslinking reaction in step v) is performed by means of thermal crosslinking or initiated by radical crosslinking or be effectuated by UV-irradiation of the polymer, and optionally performed in the presence of a further crosslinking reagent such as e.g. ethylene glycol, propylene glycol or glycerol.

7. The process or method for obtaining a diaphragm according to claim 1, wherein the crosslinking reaction in step v) is performed at an elevated temperature in the range of e.g. about 190° C., such as e.g. about 200° C., such as e.g. about 210° C., such as e.g. about 220° C., such as e.g. about 230° C., etc. and for a reaction time in range of from about 24 h.

8. The process or method for obtaining a diaphragm according to claim 1, wherein the rinsing in step vi) is performed demineralised water, or an alcohol, or DMF, or e.g. DMSO or any mixtures thereof.

9. The process or method for obtaining a diaphragm according to claim 1, wherein the post treatment in step vi) may comprise treating the diaphragm in an alkaline water solution, such as e.g. a KOH solution of a strength of about 5 wt % to about 30 wt %, and the treatment of the diaphragm may proceed in the alkaline solution for a period of about 2 h to about 48 h, such as e.g. about 12 h, or about 48 h.

10. The process or method for obtaining a diaphragm according to claim 1, wherein the process may comprise an additional step vii) which follows step vi), wherein the diaphragm is rinsed in demineralised water and subsequently boiled in demineralised water during a period of about 30 min to about 2 h, such as e.g. for about 60 min, or e.g. about 90 min.

11. A diaphragm obtainable by a process according to claim 1, or a diaphragm comprising;
i) a crosslinked polymer such as e.g. a sulfone based polymer, wherein the polymer is crosslinked with ethylene glycol or glycerol,
ii) a scaffold selected from a polymeric mesh, gauze, net or cloth etc, and
iii) a metal oxide.

12. Use of a diaphragm according to claim 11 in any electrochemical application or as an element in any electrochemical device, comprising an alkaline electrolyte, wherein the electrolyte is heated to an elevated temperature, such as in range of from about 50° C. to about 150° C., or alternatively e.g. above about 120° C., or e.g. above about 100° C., or e.g. above about 80° C. and wherein the electrolyte is an aqueous KOH-solution of a concentration of about 30 wt % or more.

13. The use according to claim 12, wherein the diaphragm is as an element in any electrochemical device or any application adapted or configured for electrolysis of water such as e.g. water splitting into oxygen and hydrogen.

14. The process or method for obtaining a diaphragm according to claim 2, wherein the functionalisation reaction in step ii) result in a sulfonation reaction providing the addition of a —SO₃H group to the polymeric binder, or wherein the functionalisation reaction in step ii) result in a halomethylation, lithiation, bromination, aminomethylation etc.

15. The process or method for obtaining a diaphragm according to claim 2, wherein the functionalisation reaction in step ii) is performed at a temperature in range of e.g. about 40° C. to about 80° C., such as e.g. about 45° C., such as e.g. about 50° C., such as e.g. about 55° C., such as e.g. about 60° C., such as e.g. about 65° C., such as e.g. about 70° C., such as e.g. about 75° C., etc. and for a period in range of about 1 h to about 48 h, such as e.g. about 1 h to about 48 h, such as e.g. about 3 h, such as e.g. about 4 h, such as e.g. about 5 h, such as e.g. about 6 h, such as e.g. about 7 h, such as e.g. about 8 h, such as e.g. about 9 h, such as e.g. about 10 h, such as e.g. about 11 h, such as e.g. about 12 h, such as e.g. about 24 h, or such as e.g. about 48 h etc.

16. The process or method for obtaining a diaphragm according to claim 3, wherein the functionalisation reaction in step ii) is performed at a temperature in range of e.g. about 40° C. to about 80° C., such as e.g. about 45° C. such as e.g. about 50° C., such as e.g. about 55° C., such as e.g. about 60° C., such as e.g. about 65° C., such as e.g. about 70° C., such as e.g. about 75° C., etc. and for a period in range of about 1 h to about 48 h, such as e.g. about 1 h to about 48 h, such as e.g. about 3 h, such as e.g. about 4 h, such as e.g. about 5 h, such as e.g. about 6 h, such as e.g. about 7 h, such as e.g. about 8 h, such as e.g. about 9 h, such as e.g. about 10 h, such as e.g. about 11 h, such as e.g. about 12 h, such as e.g. about 24 h, or such as e.g. about 48 h etc.

17. The process or method for obtaining a diaphragm according to claim 2, wherein the rinsing in step iii) is performed by rinsing the diaphragm in a suitable solvent such as e.g. demineralised water, or an alcohol, or DMF, or e.g. DMSO or any mixtures thereof and wherein the solvent may have a temperature of about 0° C. to about 5° C.6, and wherein the drying step in step iv) is performed during a period of about 24 h.

18. The process or method for obtaining a diaphragm according to claim 3, wherein the rinsing in step iii) is performed by rinsing the diaphragm in a suitable solvent such as e.g. demineralised water, or an alcohol, or DMF, or e.g. DMSO or any mixtures thereof and wherein the solvent may have a temperature of about 0° C. to about 5° C.6. The process or method for obtaining a diaphragm, and wherein the drying step in step iv) is performed during a period of about 24 h.

19. The process or method for obtaining a diaphragm according to claim 4, wherein the rinsing in step iii) is performed by rinsing the diaphragm in a suitable solvent such as e.g. demineralised water, or an alcohol, or DMF, or e.g. DMSO or any mixtures thereof and wherein the solvent may have a temperature of about 0° C. to about 5° C.6. The process or method for obtaining a diaphragm, and wherein the drying step in step iv) is performed during a period of about 24 h.

20. The process or method for obtaining a diaphragm according to claim 2, wherein the crosslinking reaction in step v) is performed by means of thermal crosslinking or initiated by radical crosslinking or be effectuated by UV-irradiation of the polymer, and optionally performed in the presence of a further crosslinking reagent such as e.g. ethylene glycol, propylene glycol or glycerol.
